(19) United States
(12) Patent Application Publication
(10) Pub. No.: US 2010/0295989 A1
(43) Pub. Date: Nov. 25, 2010

(54) IMAGE CAPTURING DEVICE AND MANUFACTURING METHOD OF SEALING STRUCTURE

(75) Inventor: Chih-Feng Cheng, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/470,496

(22) Filed: May 22, 2009

(51) Int. Cl. H04N 5/225; B29C 45/16

(52) U.S. Cl. 348/374; 264/255; 348/E05.028

(57) ABSTRACT

An image capturing device including a housing, a sealing element, a light-permeable cover and a lens module is provided. The housing has an opening portion, and the opening portion has an inner periphery and an outer periphery. The sealing element is integrated with the housing by injection molding, wherein the inner periphery and the outer periphery of the opening portion are surrounded by the sealing element. The light-permeable cover is integrated with the sealing element by injection molding and corresponding to the opening portion, wherein a periphery portion of the light-permeable cover is surrounded by the sealing element, and a containing space is defined by the housing, the sealing element and the light-permeable cover. The lens module is disposed in the containing space. In addition, a manufacturing method of a sealing structure is also provided.

### BACKGROUND OF THE INVENTION

1. Field of the Invention

The present invention generally relates to an image capturing device and a manufacturing method of a sealing structure. More particularly, the present invention relates to an image capturing device having a sealing structure and a manufacturing method of the sealing structure.

2. Description of Related Art

With the development of modern video technology, image capturing device such as digital video cameras (DVC) and digital cameras (DC) are widely used in a variety of fields. Generally, an image capturing device includes a housing, a light-permeable cover assembled to the housing and a lens module disposed in the housing. The lens module is used for forming clear images on a screen or a charge coupled device (CCD). According to car reverse cameras or driving assist cameras, the housing and the light-permeable cover are designed for forming a sealed space for protecting the lens module or other elements disposed in the housing from external substances, for example, rainwater or dust.

Conventional way for forming a sealed space is disposing an O-shape ring between the housing and the light-permeable cover, such that the gap between the housing and the light-permeable cover is sealed by elastic deformation of the O-shape ring. However, there is still probably a small gap between the O-shape ring and the housing (or the light-permeable cover). In addition, production of the O-shape ring increases the manufacturing cost of the image capturing device.

### SUMMARY OF THE INVENTION

The present invention is to provide an image capturing device with better sealing efficiency and lower manufacturing cost.

The present invention is to provide a manufacturing method of a sealing structure with better sealing efficiency and lower manufacturing cost.

As embodied and broadly described herein, the present invention provides an image capturing device including a housing, a sealing element, a light-permeable cover and a lens module. The housing has an opening portion, and the opening portion has an inner periphery and an outer periphery. The sealing element is integrated with the housing by injection molding, wherein the inner periphery and the outer periphery of the opening portion are surrounded by the sealing element. The light-permeable cover is integrated with the sealing element by injection molding and corresponding to the opening portion, wherein a periphery portion of the light-permeable cover is surrounded by the sealing element, and a containing space is defined by the housing, the sealing element and the light-permeable cover. The lens module is disposed in the containing space.

According to an embodiment of the present invention, the light-permeable cover has a ring-shape rib contacted with the sealing element.

According to an embodiment of the present invention, the outer periphery of the opening portion has a rugged area contacted with the sealed element.

According to an embodiment of the present invention, the material of the sealing element is plastic.

According to an embodiment of the present invention, the material of the housing is metal.

According to an embodiment of the present invention, the material of the light-permeable cover is glass or plastic.

As embodied and broadly described herein, the present invention provides a manufacturing method of a sealing structure. First, a first mold is provided. Then, a housing disposed at the first mold and a light-permeable cover disposed at the first mold are provided, wherein the housing has an opening portion and the light-permeable cover is corresponding to the opening portion. A second mold is provided. The second mold is pressed on the first mold, such that a first cavity is defined by the first mold and the second mold, wherein the opening portion of the housing and a periphery portion of the light-permeable cover are exposed in the first cavity. A first plastic material is injected into the first cavity to wrap the opening portion of the housing and the periphery portion of the light-permeable cover exposed in the first cavity. Finally, the first mold and the second mold are removing after the first plastic material is solidified into a sealed element warping the opening portion of the housing and the periphery portion of the light-permeable cover exposed in the first cavity.

According to an embodiment of the present invention, the first mold has a ring-shape trench and a top surface surrounded by the ring-shape trench, wherein the housing is disposed in the ring-shape trench and the light-permeable cover is disposed on the top surface.

According to an embodiment of the present invention, the light-permeable cover has a ring-shape rib defining a groove, and the first mold has a projection engaged with the groove.

According to an embodiment of the present invention, an outer periphery of the opening portion has a rugged area and is exposed in the first cavity.

According to an embodiment of the present invention, the material of the housing is metal.

According to an embodiment of the present invention, the material of the light-permeable cover is glass or plastic.

According to an embodiment of the present invention, the light-permeable cover disposed at the first mold is provided after the housing disposed at the first mold is provided, and a method of providing the light-permeable cover disposed at the first mold is provided. First, a third mold is provided. Then, the third mold is pressed on the first mold, such that a second cavity corresponding to the opening portion is defined by the first mold and the third mold. A second plastic material is injected into the second cavity. Finally, the third mold is removed after the second plastic material is solidified into the light-permeable cover.

In summary, the sealing element of the present invention is integrated with the housing and the light-permeable cover by injection molding, such that the gap between the housing and the light-permeable cover is completely sealed, and the manufacturing cost of the image capturing device is decreased because it is no need to dispose other elements for sealing between the housing and the light-permeable cover.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic perspective view showing an embodiment of the image capturing device of the present invention.

FIG. 2 is an exploded view showing the image capturing device in FIG. 1.

FIG. 3 is a partially cross-sectional view showing the image capturing device in FIG. 1.

FIG. 4A to FIG. 4E are cross-sectional views schematically showing the manufacturing process for the image capture device according to an embodiment of the present invention.

FIG. 5A to FIG. 5D are cross-sectional views schematically illustrating a method of providing the light-permeable cover by injection molding according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

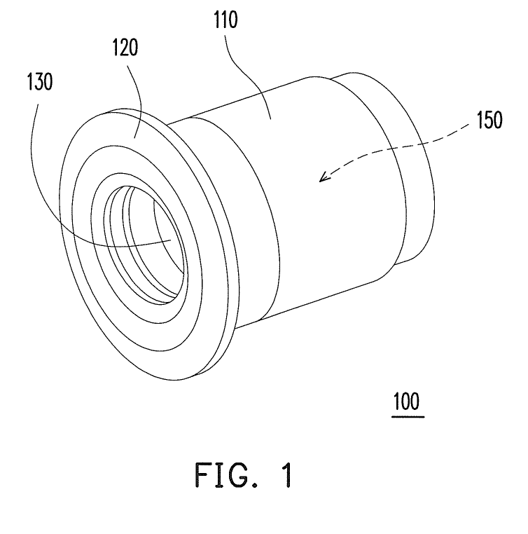

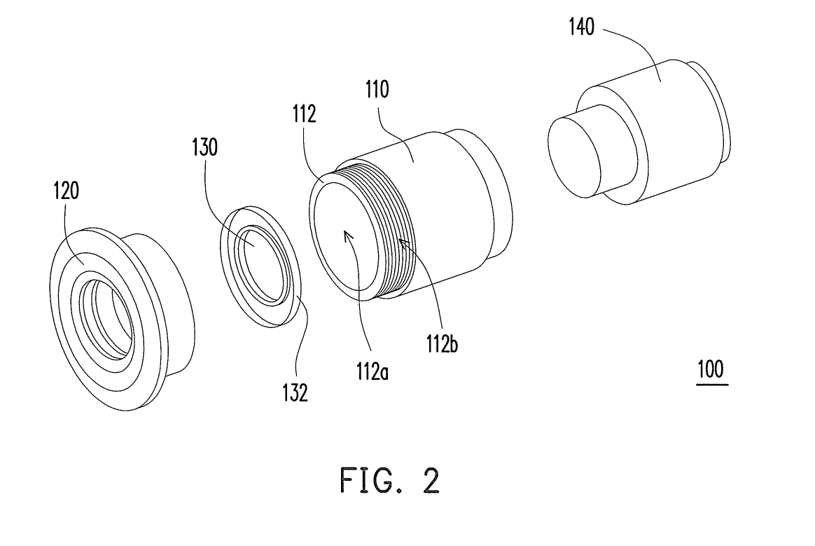

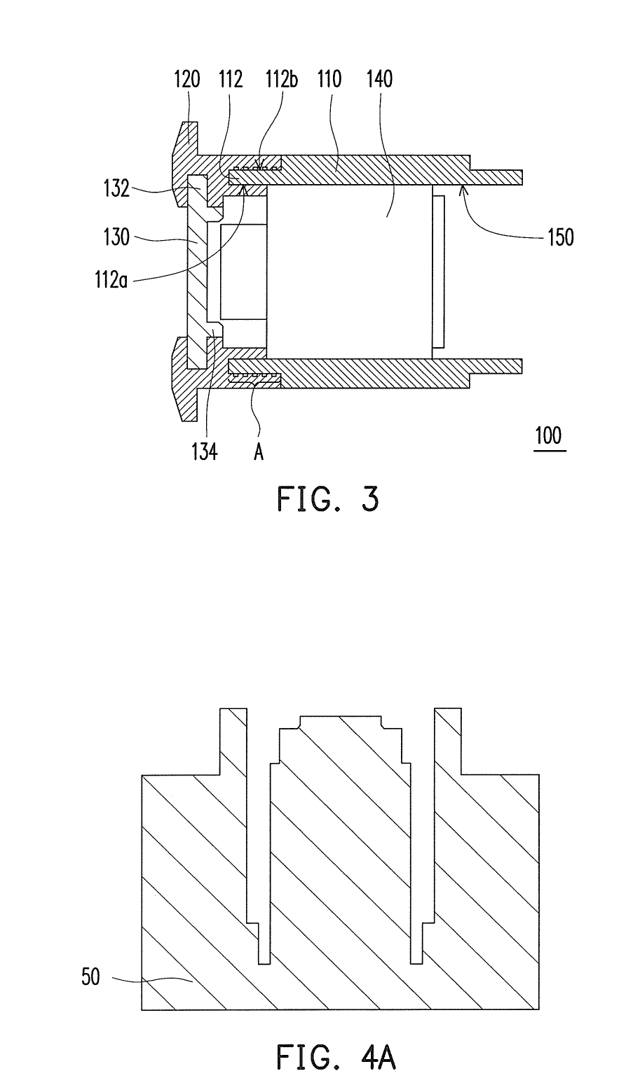

FIG. 1 is a schematic perspective view showing an embodiment of the image capturing device of the present invention. FIG. 2 is an exploded view showing the image capturing device in FIG. 1. FIG. 3 is a partially cross-sectional view showing the image capturing device in FIG. 1. Referring to FIG. 1, FIG. 2 and FIG. 3, the image capturing device 100 including a housing 110, a sealing element 120, a light-permeable cover 130 and a lens module 140.

The housing 110 has an opening portion 112, and the opening portion 112 has an inner periphery 112a and an outer periphery 112b. The housing 110 is a tube-shaped object. The sealing element 120 is integrated with the housing 110 by injection molding, wherein the inner periphery 112a and the outer periphery 112b of the opening portion 112 are surrounded by the sealing element 120. The light-permeable cover 130 is integrated with the sealing element 120 by injection molding and corresponding to the opening portion 112, wherein a periphery portion 132 (i.e. inner periphery and/or outer periphery, no limitation to the embodiment) of the light-permeable cover 130 is surrounded by the sealing element 120, and a containing space 150 is defined by the housing 110, the sealing element 120 and the light-permeable cover 130. The lens module 140 is disposed in the containing space 150 for capturing light through the light-permeable cover 130 and converting into images by an image sensor disposed on a printed circuit board. Thus, the gap between the housing 110 and the light-permeable cover 130 is sealed by the sealing element 120 for protecting the lens module from external substances, for example, rainwater or dust.

Particularly, referring to FIG. 3, the light-permeable cover 130 has a ring-shape rib 134 contacted with the sealing element 120 to increase sealing efficiency. In addition, the outer periphery 112b of the opening portion 112 has a rugged area A contacted with the sealed element 120, such that the integrating between the housing 110 and the sealing element 120 is tighter. In the embodiment, the material of the sealing element 120 can be plastic, the material of the housing 110 can be metal or alloy (stainless steel alloy or aluminum base alloy), and the material of the light-permeable cover 130 can be glass or plastic.

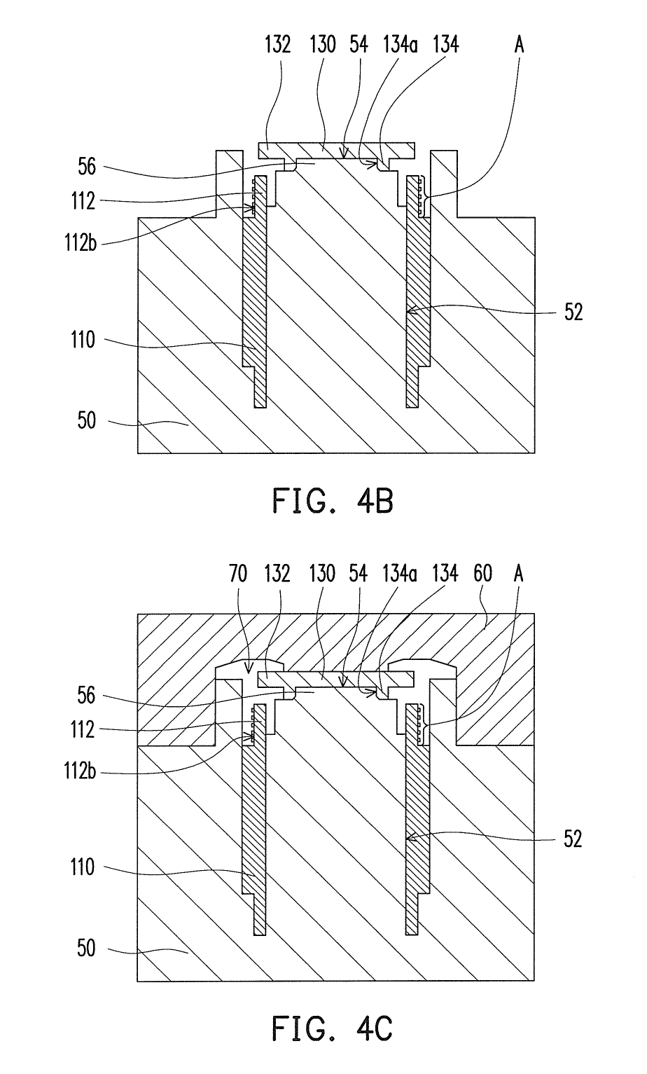

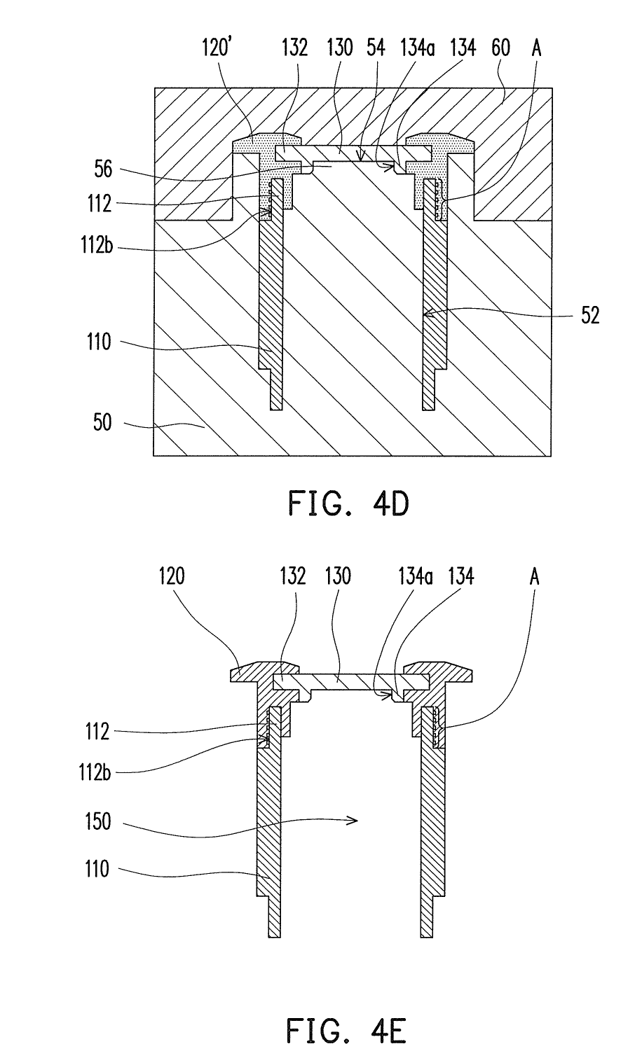

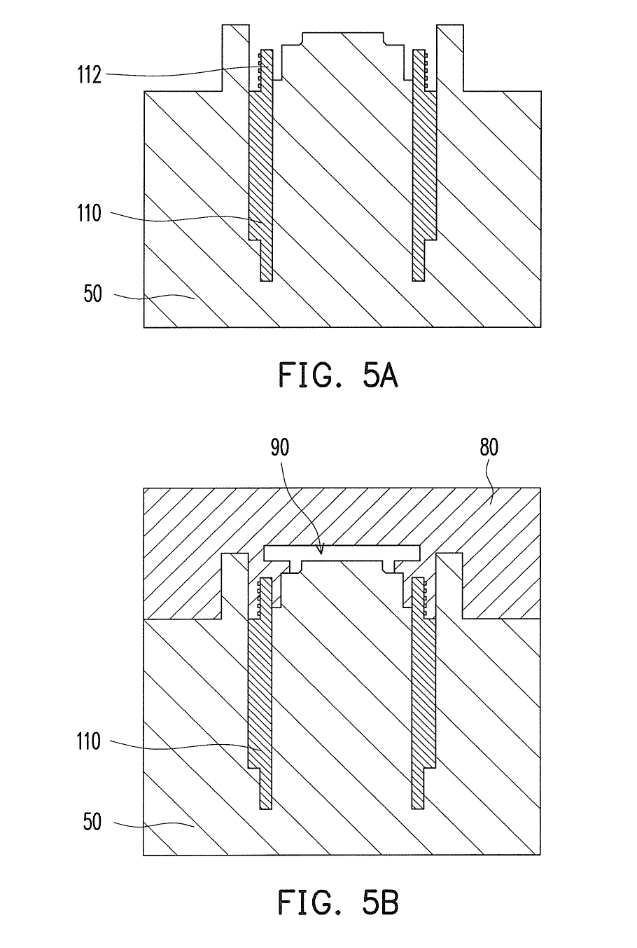

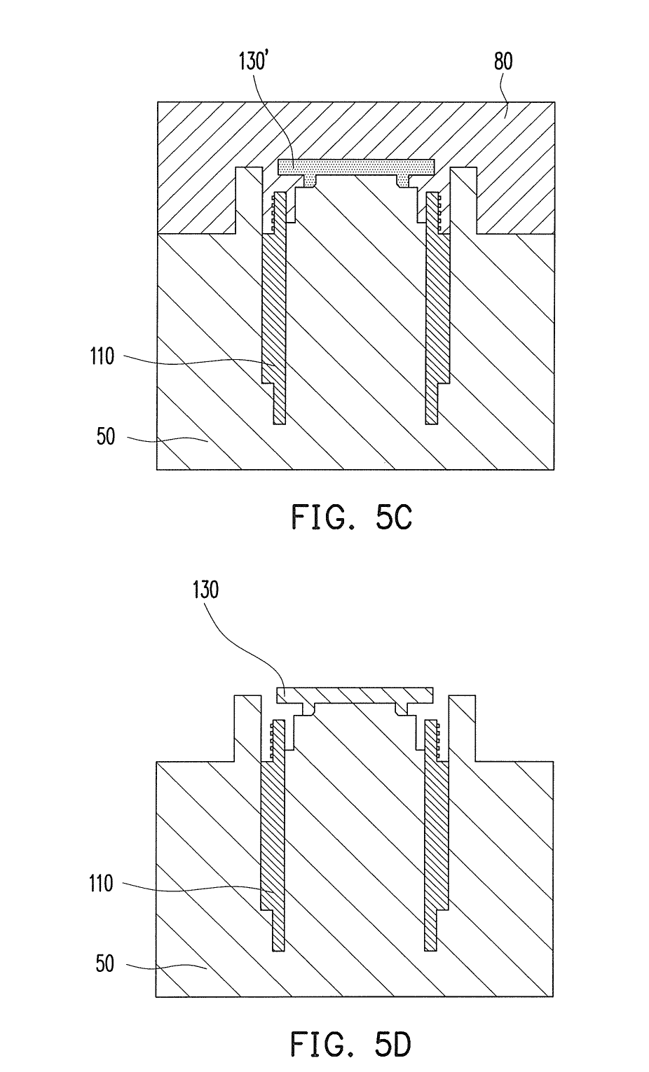

In other words, a sealing structure consists of the housing 110, the sealing element 120 and the light-permeable cover 130 is suitable for protecting the lens module 140 from rainwater, dust or other external substances. A manufacturing method of a sealing structure will be described as below by FIG. 4A to FIG. 4E and FIG. 5A to FIG. 5D.

FIG. 4A to FIG. 4E are cross-sectional views schematically illustrating the manufacturing process for the image capture device according to an embodiment of the present invention. First, referring to FIG. 4A, a first mold 50 is provided. Then, referring to FIG. 4B, a housing 110 disposed at the first mold 50 and a light-permeable cover 130 disposed at the first mold 50 are provided, wherein the housing 110 has an opening portion 112 and the light-permeable cover 130 is corresponding to the opening portion 112.

Referring to FIG. 4C, a second mold 60 is provided. The second mold 60 is pressed on the first mold 50, such that a first cavity 70 is defined by the first mold 50 and the second mold 60, wherein the opening portion 112 of the housing 110 and a periphery portion 132 of the light-permeable cover 130 are exposed in the first cavity 70. Referring to FIG. 4D, a first plastic material 120′ is injected into the first cavity 70 to wrap the opening portion 112 of the housing 110 and the periphery portion 132 of the light-permeable cover 130 exposed in the first cavity 70.

Finally, the first mold 50 and the second mold 60 are removing after the first plastic material 120′ is solidified into a sealed element 120 warping the opening portion 112 of the housing 110 and the periphery portion 132 of the light-permeable cover 130 exposed in the first cavity 70. Thus, a sealing structure consists of the housing 110, the light-permeable cover 130 and the sealing element 120 is formed and is suitable for protecting a lens module or other elements disposed in the containing space 150 from rainwater, dust or other external substances.

Particularly, referring to FIG. 4B, the first mold 50 has a ring-shape trench 52 and a top surface 54 surrounded by the ring-shape trench 52, wherein the housing 110 is disposed in the ring-shape trench 52 and the light-permeable cover 130 is disposed on the top surface 54 for being corresponding to the opening portion 112 of the housing 110. The light-permeable cover 130 has a ring-shape rib 134 defining a groove 134a, and the first mold 50 has a projection 56 engaged with the groove 134a for limiting the position of the light-permeable cover 130 relative to the first mold 50. In addition, referring to FIG. 4E, an outer periphery 112b of the opening portion 112 has a rugged area A and is exposed in the first cavity 70, such that the integrating between the housing 110 and the sealing element 120 is tighter.

In the embodiment, the material of the housing 110 can be metal, and the material of the light-permeable cover 130 can be glass or plastic. When the material of the light-permeable cover 130 is glass, the method of providing the light-permeable cover 130 disposed at the first mold 50 can be forming the light-permeable cover 130 in advance and placing the light-permeable cover 130 on the first mold 50. In addition, when the material of the light-permeable cover 130 is plastic, the method of providing the light-permeable cover 130 disposed at the first mold 50 can be injection molding.

A method of providing the light-permeable cover 130 disposed at the first mold 50 can be injection molding will be particularly described as below by FIG. 5A to FIG. 5D.

FIG. 5A to FIG. 5D are cross-sectional views schematically illustrating a method of providing the light-permeable cover by injection molding according to an embodiment of the present invention. Referring to FIG. 5A, the housing 110 is disposed at the first mold 50 first. Then, referring to FIG. 5B, a third mold 80 is pressed on the first mold 50, such that a second cavity 90 is defined by the first mold 50 and the third mold 80. Referring to FIG. 5C, a second plastic material 130′ is injected into the second cavity 90. Finally, referring to FIG. 5D, the third mold 80 is removed after the second plastic material 130′ is solidified into the light-permeable cover 130. Thus, the light-permeable cover 130 is formed on the first mold 50, and the manufacturing process showed in FIG. 4C to FIG. 4E is able to be executed thereafter.

In the present embodiment, the sealing element of the present invention is integrated with the housing and the light-permeable cover by injection molding, such that the gap between the housing and the light-permeable cover is completely sealed, and it is no need to dispose other elements for sealing between the housing and the light-permeable cover. Therefore, the sealing efficiency of the image capturing device is promoted and the manufacturing cost of the image capturing device is decreased.

It will be apparent to those skilled in the art that various modifications and variations may be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image capturing device, comprising:
a housing, having an opening portion, and the opening portion has an inner periphery and an outer periphery;
a sealing element, integrated with the housing by injection molding, wherein the inner periphery and the outer periphery of the opening portion are surrounded by the sealing element;
a light-permeable cover, integrated with the sealing element by injection molding and corresponding to the opening portion, wherein a periphery portion of the light-permeable cover is surrounded by the sealing element, and a containing space is defined by the housing, the sealing element and the light-permeable cover; and
a lens module, disposed in the containing space.

2. The image capturing device as claimed in claim 1, wherein the light-permeable cover has a ring-shape rib contacted with the sealing element.

3. The image capturing device as claimed in claim 1, wherein the outer periphery of the opening portion has a rugged area contacted with the sealed element.

4. The image capturing device as claimed in claim 1, wherein the material of the sealing element is plastic.

5. The image capturing device as claimed in claim 1, wherein the material of the housing is metal.

6. The image capturing device as claimed in claim 1, wherein the material of the light-permeable cover is glass or plastic.

7. A manufacturing method of a sealing structure, comprising:
providing a first mold;
providing a housing disposed at the first mold and a light-permeable cover disposed at the first mold, wherein the housing has an opening portion and the light-permeable cover is corresponding to the opening portion;
providing a second mold;
pressing the second mold on the first mold, such that a first cavity is defined by the first mold and the second mold, wherein the opening portion of the housing and a periphery portion of the light-permeable cover are exposed in the first cavity;
injecting a first plastic material into the first cavity to wrap the opening portion of the housing and the periphery portion of the light-permeable cover exposed in the first cavity; and
removing the first mold and the second mold after the first plastic material is solidified into a sealed element warping the opening portion of the housing and the periphery portion of the light-permeable cover exposed in the first cavity.

8. The manufacturing method of a sealing structure as claimed in claim 7, wherein the first mold has a ring-shape trench and a top surface surrounded by the ring-shape trench, wherein the housing is disposed in the ring-shape trench and the light-permeable cover is disposed on the top surface.

9. The manufacturing method of a sealing structure as claimed in claim 7, wherein the light-permeable cover has a ring-shape rib defining a groove, and the first mold has a projection engaged with the groove.

10. The manufacturing method of a sealing structure as claimed in claim 7, wherein an outer periphery of the opening portion has a rugged area and is exposed in the first cavity.

11. The manufacturing method of a sealing structure as claimed in claim 7, wherein the material of the housing is metal.

12. The manufacturing method of a sealing structure as claimed in claim 7, wherein the material of the light-permeable cover is glass or plastic.

13. The manufacturing method of a sealing structure as claimed in claim 7, wherein the light-permeable cover disposed at the first mold is provided after the housing disposed at the first mold is provided, and a method of providing the light-permeable cover disposed at the first mold comprises:
providing a third mold;
pressing the third mold on the first mold, such that a second cavity corresponding the opening portion is defined by the first mold and the third mold;
injecting a second plastic material into the second cavity; and
removing the third mold after the second plastic material is solidified into the light-permeable cover.
